(19) United States
(12) Patent Application Publication
(10) Pub. No.: US 2009/0178662 A1
(43) Pub. Date: Jul. 16, 2009

(54) WATER HEATER GAS APPLIANCE

(76) Inventor: David Deng, Chino Hills, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/268,377

(22) Filed: Nov. 10, 2008

(30) Foreign Application Priority Data
Nov. 9, 2007 (CN) 200710135082.0
Nov. 19, 2007 (CN) 200720042574.0

(51) Int. Cl. F24C 13/00; G05D 23/00; F24C 15/20

(52) U.S. Cl. 126/5; 700/299; 126/299 R

(57) ABSTRACT

An apparatus can have and combine certain aspects of a stove, a water heater and an exhaust system. The apparatus may further have and combine certain aspects of additional appliances such as a dishwasher, a gas oven, an electric oven, a disinfection cabinet and a cabinet. The apparatus can advantageously use one exhaust vent and one gas hook up while performing multiple functions.

### CROSS-REFERENCE TO RELATED APPLICATIONS

N/A

### BACKGROUND OF THE INVENTION

1. Field of the Invention

Certain embodiments disclosed herein relate generally to heating devices, and relate more specifically to fluid-fueled heating devices.

2. Description of the Related Art

Many varieties of general heaters, water heaters, stoves, and other appliances utilize pressurized, combustible fuels and are vented to the outside. However, such devices and certain components thereof have various limitations and disadvantages. In addition, homes and businesses have limited space and limited numbers of access points for utility hook-ups and exhaust vents.

### SUMMARY OF THE INVENTION

In certain embodiments, a water heater gas appliance can comprise a gas inlet, a water inlet, a collecting tank, a cooking stove, a heating coil, a water flow control valve configured to control the flow of water to at least one of the heat exchanger and the collecting tank and a hot water outlet. The cooking stove can comprise a first gas burner configured for heating and preparing food and a gas controller configured to control the flow of gas from the gas inlet to the first gas burner. The heating coil can comprise at least one of a stove tubing heating coil and a first flue heating coil, wherein the stove tubing heating coil can be configured to heat a flow of water when the first burner is in operation and the first flue heating coil can be configured to heat a flow of water when exhaust air is passed through an air exhaust system. The heated water can be stored in the collecting tank for use by a user.

In some embodiments, the water heater gas appliance can comprise a water pump configured to circulate a flow of water between the collecting tank and the stove tubing heating coil. In some embodiments, the water heater gas appliance can comprise a water heater, wherein the water heater can comprise a second gas burner and a heat exchanger configured to heat a flow of water through the heat exchanger, the heat exchanger configured for direct heating by the second gas burner.

In certain embodiments an air exhaust system can comprise first and second exhaust inlets and an exhaust outlet. The first exhaust inlet can be configured to exhaust air from a stove and the second exhaust inlet can be configured to exhaust air from a water heater. The exhaust outlet can be configured to exhaust the combined air from both the first and second exhaust inlets.

In some embodiments, a water heater gas appliance can comprise an air exhaust system and first and second flue heating coils. The first flue heating coil can be within the exhaust outlet and the second flue heating coil can be within the second exhaust inlet.

In some embodiments an apparatus can comprise a swappable appliance wherein the apparatus can be configured with a space for installing the swappable appliance. The space can be configured such that the swappable appliance can be swapped out for another swappable appliance. The swappable appliance can be selected from the group comprising: a cabinet, a dishwasher, an electric oven, a gas oven and a disinfection cabinet.

In some embodiments an apparatus can comprise a room heating assembly. The room heating assembly can comprise a second water heater; and a plurality of pipes. The second water heater can be configured to be heated by the second gas burner to thereby heat a flow of fluid in the second water heater. The room heating assembly can be a closed system configured to circulate the fluid through the plurality of pipes to thereby transfer the heat in the fluid to an environment and configured to then circulate the fluid back to the second water heater to be heated again.

In certain embodiments, a combustible fuel apparatus can comprise a fuel inlet, a water inlet, a stove and a water heater. The stove can comprise a first burner and a first fuel control valve for controlling a flow of fuel from the fuel inlet to the first burner. The water heater can comprise a first heat exchanger, a second heat exchanger, a second burner configured to heat the first heat exchanger and a second fuel control valve for controlling a flow of fuel from the fuel inlet to the second burner. The apparatus can be configured to heat the flow of water with either or both of the first and second heat exchangers.

In some embodiments the second heat exchanger can comprise at least one of a stove heating coil and a first flue heating coil, wherein the stove heating coil can be configured to heat the flow of water when the first burner of the stove is in operation and the flue heating coil can be configured to heat a flow of water when exhaust air is passed through an air exhaust system.

In some embodiments, the combustible fuel apparatus can further comprise a collecting tank wherein the first and second heat exchangers are configured to direct heated water to the collecting tank. In some embodiments, the combustible fuel apparatus can further comprise a water pump wherein the water pump can be configured to circulate a flow of water between the collecting tank and the second heat exchanger.

In some embodiments, an exhaust system for a water heater gas appliance can comprise first and second exhaust air inlets, an outlet, an exhaust fan in the first exhaust air inlet and a filter in the first exhaust air inlet. The first and second exhaust air inlets can exhaust into the outlet and the second exhaust air inlet can be configured to not receive exhaust from the first inlet. The outlet can comprise an elbow. The elbow can have two parallel chambers extending though at least part of the length of the elbow, wherein one of the two chambers connects with the first inlet and the other chamber connects with the second inlet, the chambers configured such that exhaust from one of the chambers will not travel back to source of the exhaust of the other chamber.

### BRIEF DESCRIPTION OF THE DRAWINGS

Various embodiments are depicted in the accompanying drawings for illustrative purposes, and should in no way be interpreted as limiting the scope of the inventions.

FIG. 1 is a schematic view of an embodiment of a water heater and gas appliance in a building.

FIG. 2 is a perspective view of an embodiment of a water heater and gas appliance.

FIG. 3 is a partial disassembled perspective view of the embodiment of a water heater and gas appliance of FIG. 2.

FIG. 4 is a schematic view of a water heater and gas appliance.

FIG. 5 is schematic side view of an embodiment of an exhaust system.

FIG. 6 is a partially exploded perspective view of another embodiment of a water heater and gas appliance.

FIGS. 6A and B are detail views of part of a gas stove and a stove heating coil.

FIG. 6C is a detail view of part of an electric stove and a stove heating coil.

FIG. 6D is a detail view of part of another embodiment of a gas stove and a stove heating coil.

FIG. 7 is a schematic view of another embodiment of a water heater and gas appliance.

FIGS. 8A-C are flow charts that illustrate certain paths and/or methods for heating a fluid, such as water.

FIGS. 9A-E are flow charts that illustrate certain paths and/or methods for heating a fluid, such as water.

FIG. 10 is a schematic view of another embodiment of a water heater and gas appliance and a room heater system.

FIG. 11 is a schematic view of another embodiment of a water heater and gas appliance and a room heater system.

### DETAILED DESCRIPTION OF THE PREFERRED EMBODIMENT

In certain building environments there exists a need for limiting the number of vents to the outside that leave a room, apartment, house and/or other type of structure. Limiting the number of vents can decrease certain costs of manufacture and can provide certain safety benefits such as limiting the gaps or holes in fireproof insulation, as an example. In other situations, for example in preexisting buildings, when a new tenant moves into the building the tenant may have a need for more vents then are currently present. Unfortunately, it may be difficult to increase the number of vents.

In still other situations the building, such as an apartment building, may have a communal vent system. In such a system, the individual units, or apartments, may have a vent that is tied in with a central vent instead of being vented directly to the outside. Here again it can be difficult and costly to tie in additional vents to the communal vent system. For example, adding a new vent may require the additional expense of installing long lines of duct work to connect with the central vent.

In addition to exhaust vents, other household inlets and outlets such as gas hook-ups and water hook-ups can have similar constraints and reducing their numbers may have similar benefits. There may only be one gas hook-up for an apartment but the tenant may desire to use multiple appliances that require gas hook-ups.

Applicants have created an apparatus 50 that, in certain embodiments, simplifies and combines certain appliances and/or uses of ventilation and/or inlets and outlets, such as gas hook-ups 46 or water hook-ups 48 in a building 40.

As another example, in the construction of an apartment complex or multiplex with tens or hundreds of apartments, it may be desirable to reduce the number of outlets to the outside. As explained previously, this can be for both cost savings and safety precautions and can also provide other benefits. One benefit of reducing the number of vents to the outside for an apartment is a reduction in exposure to the outside elements. Limiting the number of vents can also beneficially reduce heating and/or cooling costs of the building as less of the outside weather can influence the conditions inside of the building. Increasing the number of vents can also require additional costs related to specialized traps or methods to reduce this exposure. These methods can be undesirable, costly and/or non-aesthetically pleasing.

Another problem a new tenant may experience is the difficulty of receiving approval for modification or renovations to the building, house or apartment. The renovations and approvals necessary, such as obtaining permits or approval by a city planning commission, zoning board or an apartment board can be timely and financially consuming. For these additional reasons, there also exists a need to combine appliances and/or other uses of ventilation, gas lines, water lines, etc.

As will be shown, besides the benefits of combining appliances and/or uses of inlets and outlets that require points of access into a room, many synergies are also available through these combinations. There are also difficulties that must be overcome to facilitate such combinations.

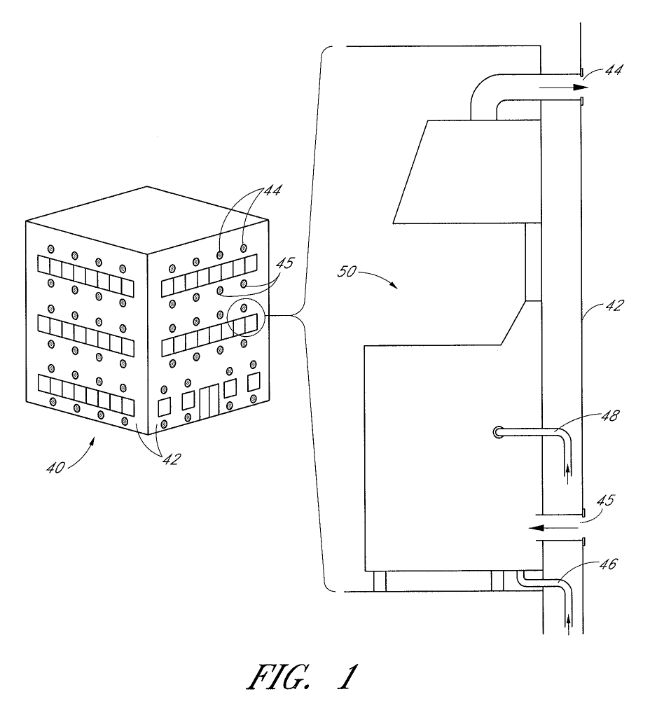

A multi-tenant apartment building 40 is shown in FIG. 1. The building 40 has exterior walls 42, ventilation inlets 45 and ventilation outlets 44. Each apartment has one ventilation inlet 45 and one ventilation outlet 44. Also shown is a cross-sectional detail view of an apartment with part of an exterior wall 42. The detail view illustrates an apparatus 50 that conveniently and effectively combines certain aspects of different appliances to best utilize the one ventilation inlet 45, the one outlet 44 and the one gas hook-up 46 in the apartment. The apparatus 50, as shown, utilizes a single exhaust vent, as well as, one fuel inlet 46 and one water inlet 48 and at the same time combines multiple functions and appliances. As can be seen in the representation of the building 40, this greatly simplifies the number of access points to the outside and thus the expenses that are associated with such access points.

In certain embodiments, the apparatus 50 can comprise a multi-functional gas heater system. In certain embodiments, the apparatus 50 can comprise a utility heater, related to a kitchen appliance, especially to a multi-functional sectional stove, which can not only cook but also produce hot water, and comprise an exhausting system. In the currently available gas stoves, none are known to have hot water supply systems. The apparatus 50, as described herein and according to the different embodiments, can advantageously combine needed functions for cooking and hot water in a convenient and cost saving device.

Additionally, the apparatus 50 can use single hook ups for the differing needs of the unit to result in a space saving compact design. Thus, the apparatus 50 can bear the advantage of having multi-functions, with a low cost and a simple structure.

In some embodiments, the apparatus 50 can use the ventilation inlet 45. In some embodiments, the apparatus 50 does not require the use of a ventilation inlet 45. For example, some embodiments can comprise apparatus with low BTU requirements. Thus air flow in addition to what is available in the room where the apparatus is installed is not required. In some embodiments, the apparatus 50 can require additional air flow from a ventilation inlet 45. In these embodiments the additional air flow can comprise a forced air flow or a passive air flow. Additional air flow can be required where the apparatus 50 has high BTU requirements. For example, an apparatus 50 used to heat an apartment may have high BTU requirements.

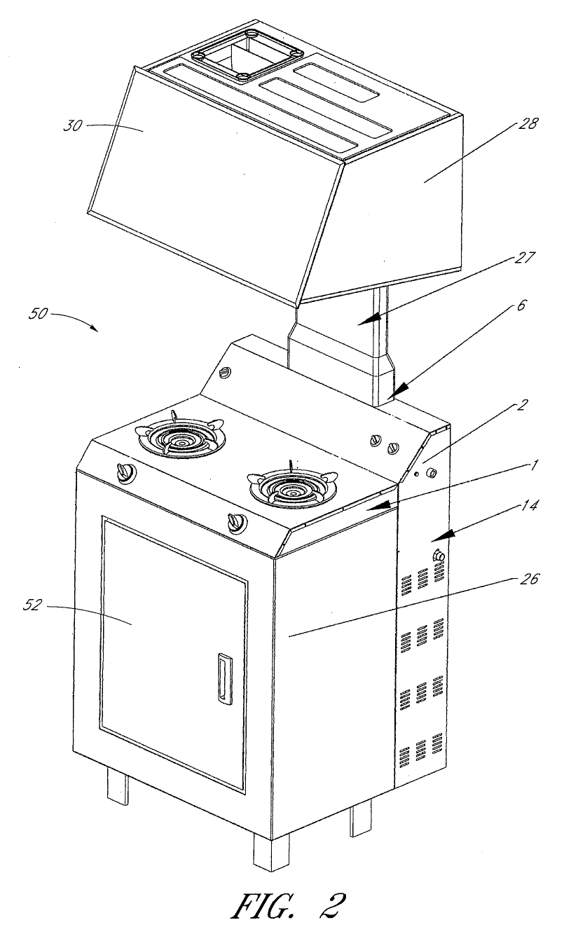

Turning now to FIG. 2, an embodiment of the apparatus 50 will be described. As depicted, water heater and gas appliance 50 can include a stove 1, a water heater 2 and an exhaust assembly or system 28. A cabinet 52 is also shown. In certain embodiments, the space where the cabinet 52 is shown can comprise other appliances or combinations of appliances as will be described in more detail hereinafter.

The stove 1 and water heater 2 can use a combustible gas or fuel. In other embodiments, at least one of the stove 1 and water heater 2 can use electricity instead of gas. For convenience in describing the appliance 50, the appliance can be divided into three regions: the front shell 26, the back shell 14 and the hood 30. In certain embodiments, the appliance 50 can be manufactured in three different sections corresponding to the regions above. It will be appreciated that while there are significant advantages to the configuration described, the regions could be interchanged.

As shown, the water heater 2 is installed in the back shell 14, the stove 1 and cabinet 52 are installed in the front shell 26 and the exhaust system 28 is installed in the hood 30. The exhaust system 28 can also comprise duct 27 and connecting duct 6. Duct 27 and connecting duct 6 can direct the exhaust from the water heater 2 in the back shell 14 to the exhaust system 28.

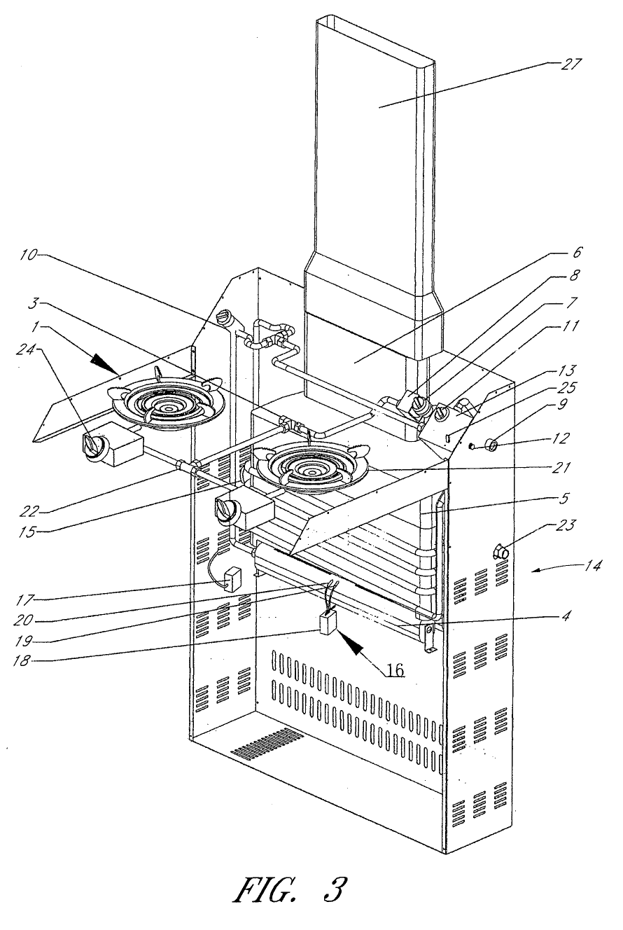

Moving now to FIG. 3, a partial disassembled perspective view of an embodiment of apparatus 50 is shown. This view shows some of the synergies created by the disclosed embodiment combining a stove 1 with a water heater 2. As illustrated the stove 1 is a gas stove and the water heater 2 is a gas water heater. The stove 1 and water heater 2 can be connected to the gas supply by pipe tie-in 3.

According to certain embodiments as shown, the stove 1 can include a stove burner 21, a stove gas inlet 22 and a stove burner controller 24. Inlet 22 can connect with pipe tie-in 3, controller 24 and stove burner 21 by corresponding gas pipe.

In certain embodiments, the water heater 2 includes a burner 4, installed in the back shell 14, and a heat exchanger 5. The burner 4 can be installed underneath the heat exchanger 5 so as to heat a fluid, such as water, within the heat exchanger 5. In some embodiments, the heat exchanger 5 is a water tank. In some embodiments, the heat exchanger 5 is a pipe or a series of pipes. Preferably, the heat exchanger 5 is made from metal. In some embodiments, the heat exchanger 5 is a pipe or a series of pipes and the water heater 2 is a tankless water heater. Desirably the heat exchanger 5 is adjacent the burner 4 and preferably within two inches of the burner flame at its maximum flame height and more preferably close enough to be contacted by the flame of the burner at its maximum height, its median flame height or ⅓ its maximum flame height. The gas line for the water heater 2 can travel from the pipe tie-in 3 to the burner 4. In certain embodiments, the water heater 2 can comprise a gas capacity adjusting valve 7. The gas capacity adjusting valve 7 can control the flow of gas from the gas inlet to the burner 4. In some embodiments the gas line can have an electromagnetic valve 8.

The water line for the water heater 2 can comprise a water inlet 9, the heat exchanger 5 and a hot water outlet 23. In FIG. 3, the water inlet 9 and hot water outlet 23 of appliance 2 are located on the same side of the back shell 14. Where the heat exchanger 5 is a water tank, the cold water can added to the tank at the bottom. Then as the water is heated, the hot water will rise and the cold water will sink. The hot water outlet 23 on a tank can be near the top of the tank to take the hot water that has risen to top.

The water line of some embodiments can comprise a flow capacity adjusting valve 11. The water line of some embodiments can comprise a pressure regulator 12. As shown in FIG. 3, there is a power switch 25 near flow capacity adjusting valve 11.

In some embodiments, the water heater's 2 control valves of the water supply 11 and the gas supply 7 can be connected with the water/gas linkage valve 13. In some embodiments, the water heater's 2 control valves of the water supply 11 and the gas supply 7 can be connected with the summer-winter status switch 10.

Though described herein as a water line and a water heater 2, the disclosure also includes other types of fluid heaters, as well as other types of fluids and fluids in different phases. For example, the heater 2 could have a water line going in and a steam line going out. The steam can be heated further in some embodiments. The fluid used and produced, such as hot water or steam, can have many uses. These uses include, but are not limited to: general heating of the room, building, floor, etc.; cleaning, disinfecting, washing, etc; and other household uses. The fluid can be connected to other appliances and facilities such as sinks, dishwashers, clothing washers, showers, tubs, heating pipes, etc.

The apparatus 50 can also include an igniter apparatus 16. The igniter apparatus can include a power supply 17, a control box 18, and a sensor pin 20. The power supply 17 provides a voltage to the control box 18. The sensor pin 19 and pilot 20 are connected with the control box 18 and controlled by it. In some embodiments, the igniter apparatus 16 comprises the electromagnetic valve 8.

According to certain embodiments, the apparatus 50 can comprise a temperature controller 15. The temperature controller 15 can comprise a temperature sensor installed near to or within the heat exchanger 5. The temperature controller 15 can be configured to regulate certain aspects of the apparatus 50. In some embodiments, the temperature controller 15 can cut off the power supply, when the fluid temperature exceeds a set value. In some embodiments, the temperature controller 15 can close off the flow of gas to the burner 4 when the temperature sensor reaches or exceeds a set temperature. For example, the temperature controller can be electrically connected with the electromagnetic valve 8 to shut off the gas flow to the burner 4. In some embodiments, the temperature controller 15 can regulate the flow of gas to burner 4 to decrease or increase the supply of gas to the burner. For example, the temperature controller 15 can be connected with the gas capacity adjusting valve 7. This can advantageously decrease or increase the temperature of the fluid being heated in the heater 2. In some embodiments, the temperature controller can regulate the flow of fluid into the heater 2 that is being heated. For example, the temperature controller 15 can be connected with the flow capacity adjusting valve 11. In these ways the temperature controller 15 can act as a safety shut-off or a safety mechanism to regulate the temperature of the fluid in the heater 2.

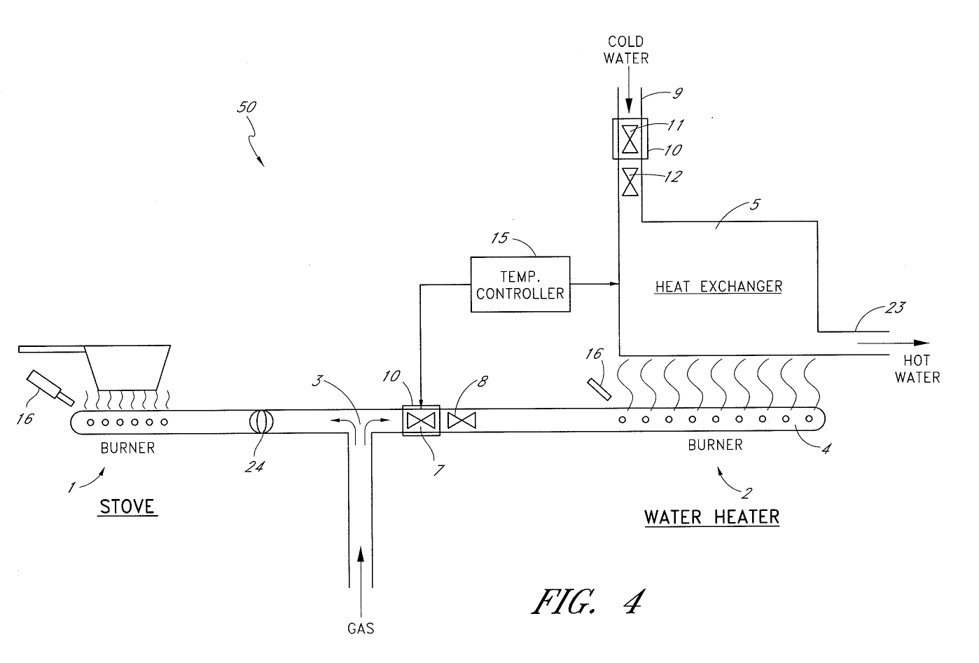

Turning now to FIG. 4, the working procedure according to some embodiments will be described. As shown, gas fuel comes through the inlet pipe tie-in 3 and separates, one stream to the gas stove 1, and the other stream to the water heater 2. For the stove 1, the controller 24 and igniter system 16 can control the gas flow and igniting of the gas to be able to use the stove 1, for example, to prepare food.

Water can enter the water heater 2 through the water inlet 9. The flow of water can be controlled by the flow capacity adjusting valve 11 and the pressure controlled by the pressure regulator 12. The water enters into the heat exchanger 5 where it can be heated by the burner 4. The hot water can flow out of the heat exchanger 5 through the hot water outlet 23. The hot water can then be used for various purposes, such as those described herein.

Gas can enter the water heater 2 by passing through the inlet pipe tie-in 3, through the gas flow adjusting valve 7 and the electromagnetic valve 8 to the burner 4. The water-gas linkage valve 13 can control or connect/disconnect the flow of gas. For example, when water is flowing through the flow capacity adjusting valve 11, the gas flow adjusting valve 7 and/or the electromagnetic valve 8 can remain open so that gas fuel enters the water heater 2. Conversely, when water is not flowing through the flow capacity adjusting valve 11, the gas flow adjusting valve 7 and/or the electromagnetic valve 8 can shut, thereby blocking gas flow from entering the water heater 2. At the same time, the water-gas linkage valve 13 can also adjust the fan of the exhaust system 28 to a low-speed when water is flowing through the flow capacity adjusting valve 11.

The gas flow adjusting valve 7 and the igniter system 16 can control the gas flow and igniting of the gas to be used in the water heater 2. As the water heater 2 burns the gas at the burner 4, the water within the heat exchanger 5 will begin to increase in temperature. When the temperature exceeds a set valve, the temperature controller 15 can shut the gas flow adjusting valve 7. Alternatively, the temperature controller 15 can decrease the flow of gas through the gas flow adjusting valve 7. This can increase the safety of the users of the water heater 2 and apparatus 50.

Lastly, as will be described more fully hereinafter, smoke and waste gas produced by the water heater 2 can pass upwards through the connecting duct 6 and duct 27 to the exhaust system 28 (FIGS. 2 and 3). The waste can then be directed outside through the ventilation outlet 44 in the exterior wall 42 (FIG. 1). At the same time, smoke and waste gas from the stove 1 can travel upwards into the hood 30 to also be directed outside through the outlet 44 in the exterior wall 42. The water heater 2 and stove 1 can be used at the same time without any interference as both can exhaust through the exhaust system 28 simultaneously.

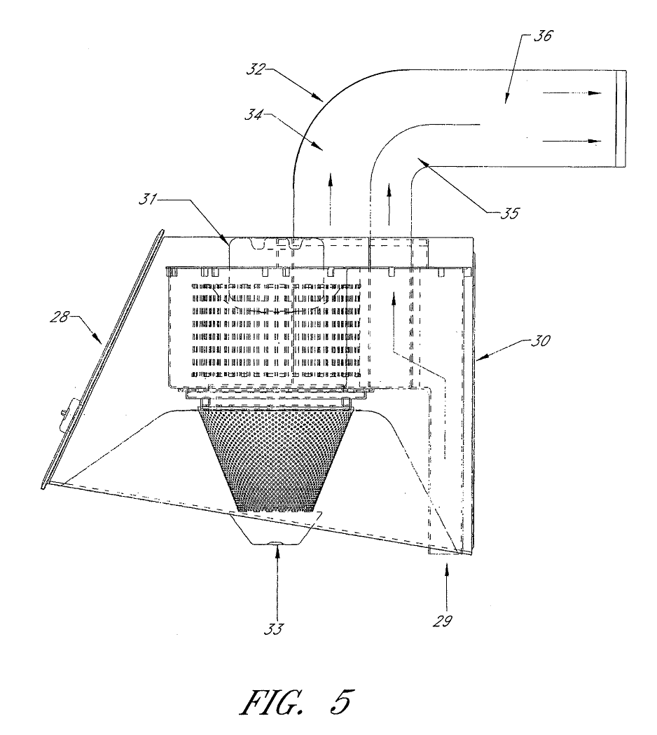

Looking now to FIG. 5, an embodiment of an exhaust system 28 will be described. An exhaust system 28 can comprise a hood 30, an exhaust fan and filter assembly 31 and a smoke exhausting pipe 32. The exhaust fan and filter assembly 31 can be installed in the hood 30. As shown, the exhaust system 28 has a first or main inlet 33 and a second or minor inlet 29. FIG. 5 also shows that smoke exhausting pipe 32 has a first or main pipe 34 and a second or minor pipe 35. Main inlet 33 and minor inlet 29 are illustrated connecting to main pipe 34 and minor pipe 35 respectively, which create separate corresponding channels through at least part of the smoke exhausting pipe 32. The smoke exhausting pipe 32 of some embodiments can be an elbow. The shape of the elbow can be an approximately 90 degree elbow. The elbow can also have a turn that is less than or more than 90 degrees, such as between 75 and 115 degrees. In some embodiments, the first pipe 34 may be smaller than the second pipe 35.

Referring now to FIGS. 2, 3 and 5 the use of some embodiments of the exhaust system 28 will be described in more detail. When the stove 1 is in use, smoke, waste gas and/or other exhaust can rise up into the hood 30. The exhaust can rise up on its own or it can be drawn upwards through the use of a fan which can be part of the exhaust fan and filter assembly 31. The exhaust can enter or be drawn into the exhaust system 28 through the main inlet 33. Once in the main inlet 33, the exhaust can pass through the exhaust fan and filter assembly 31 before entering the main pipe 34 of the smoke exhausting pipe 32. The exhaust can then be removed to the outside environment through the ventilation outlet 44 in the exterior wall 42 (FIG. 1).

Still referring to FIGS. 2, 3 and 5, the exhaust from the water heater 2 can take a different path. Exhaust from the water heater 2 can pass upwards through the connecting duct 6 and duct 27 to minor inlet 29. Once in the minor inlet 29, the exhaust can pass into the minor pipe 35 of the smoke exhausting pipe 32. Once in the smoke exhausting pipe 32, the waste can then be directed outside through the ventilation outlet 44 in the exterior wall 42 (FIG. 1).

The exhaust system 28 can beneficially remove exhaust from the apparatus 50 while utilizing only one ventilation outlet 44. Thus, even though the apparatus can perform multiple functions and combine multiple appliances, only one ventilation outlet 44 is needed. The exhaust system 28 can advantageously combine the exhaust from different appliances to exhaust the waste while maintaining the waste and exhaust from different appliances separate so as not to interfere with the use of either appliance. For example, the exhaust from the stove 1 can pass through a exhaust fan and filter assembly 31. The exhaust fan and filter assembly 31 can filter out large particulate matter and/or decrease the amount of particles in the exhaust. This can help ensure that the waste particles do not interfere with the use of the water heater 2. In addition, the smoke exhausting pipe 32 can have a major 34 and minor 35 pipe which maintain separation of the exhaust through at least part of the length of the smoke exhausting pipe 32. As shown in FIG. 5, separation is maintained as the pipe 32 rises and as it begins to curve horizontally. This separation can help ensure that waste from the major pipe 34 does not travel downward into the minor pipe 35 and into the water heater 2. This separation can also help ensure that waste from the minor pipe 34 does not travel up and then downward into major pipe 35 and out the main inlet 33 over the stove 1 area. It will be appreciated, that the major pipe 34 and the minor pipe 35 may be formed by a single tube, separated into separate pipes by means of an internal divider or baffle.

The smoke exhausting pipe 32 can comprise a mixing chamber 36. The mixing chamber 36 can be an area of the smoke exhausting pipe 32 where the separation between the major pipe 34 and the minor pipe 35 ends. In the mixing chamber 36 the exhausts from each pipe 34, 35 can be free to mix and combine. In some embodiments, the smoke exhausting pipe 32 does not have a mixing chamber 36 and the exhausts are combined after exiting the smoke exhausting pipe 32.

As shown in FIG. 2 and described above, some embodiments of the appliance or apparatus 50 can comprise a stove 1, a water heater or first water heater 2, an exhaust system 28 and a cabinet 52. This combination and other related combinations beneficially only require limited access points such as one gas hook-up 46, one water hook-up 48 and one exhaust vent 44. Not only does the apparatus 50 use the single hook ups for the differing needs of the apparatus but the apparatus is also beneficially a space saving compact design. This multi-functional gas heating system can also comprise additional appliances. For example, additional appliances can replace or be combined with the cabinet 52. In some embodiments, the additional appliances combinable with the apparatus 50 can include, but are not limited to: a dishwasher, a disinfection cabinet, a gas oven, an electric oven, etc. These appliances can make use of the gas hook-up or hot water provided by the apparatus 50. In addition, further duct work can be added where necessary to combine the exhausting functions. These features can provide additional cost savings and space saving benefits.

In some embodiments, the apparatus 50 can comprise a modular design that allows for simple and easy interchangeability between the appliances installed in the apparatus 50. Thus, the modular design allows for a new tenant or new owner to replace or swap out one component or appliance for another. For example, where a first tenant may have installed a disinfection cabinet, a second tenant may prefer a gas dishwasher. This second tenant may easily uninstall the disinfection cabinet and install the dishwasher without having to replace the entire apparatus 50. This can provide additional cost savings and benefits to the ultimate user.

In some embodiments, the apparatus 50 of FIG. 2 can comprise a modular design wherein the cabinet 52 can be configured such that other appliances can fit within at least part of the cabinet 52. In such an embodiment, the cabinet can be configured with tie-ins for gas or water and with electrical outlets. In this way the appliance can be quickly and easily installed within the cabinet.

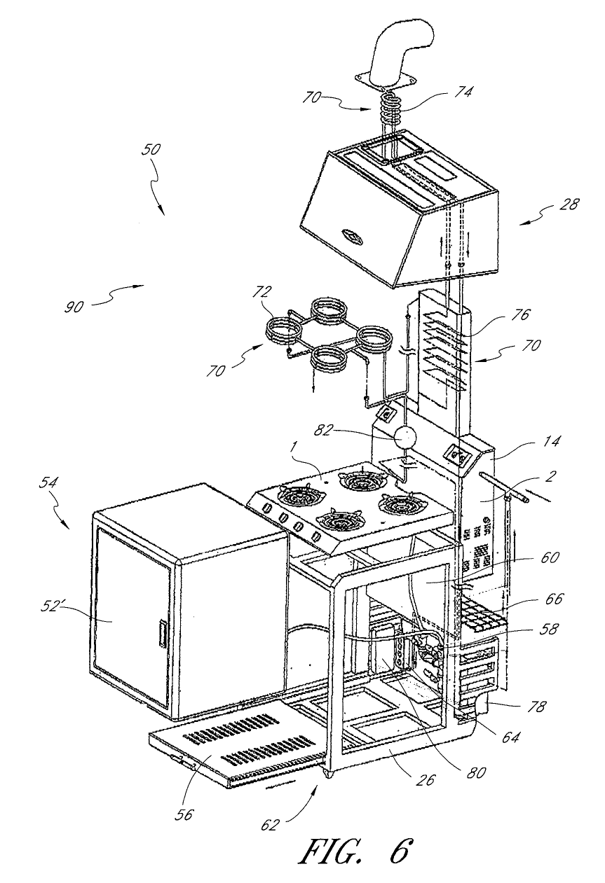

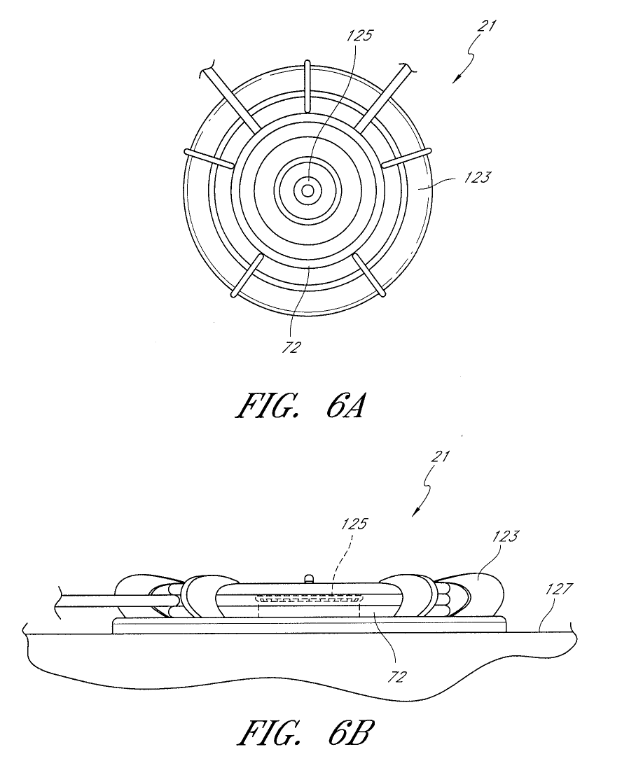

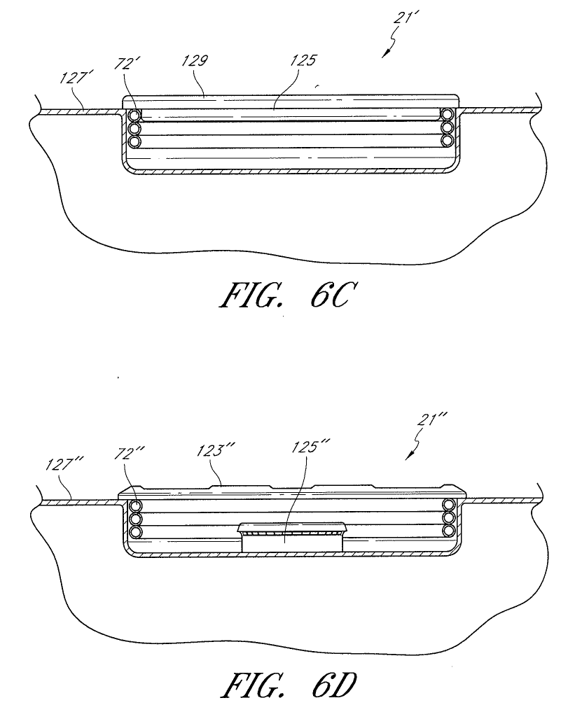

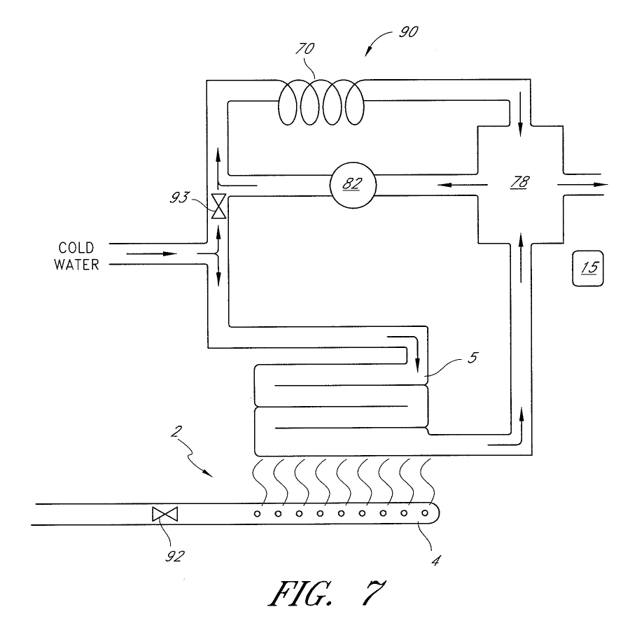

In some embodiments, such as that shown in FIG. 6 the entire cabinet 52′ can be removable so that another unit or appliance can be installed in its place. The cabinet 52′ can be a swappable appliance 54. Thus, having a swappable appliance 54 can allow for more customization of the apparatus 50. In some embodiments, as also shown in FIG. 6, the front shell 26 can comprise a pullout 56. The pullout 56 can comprise a guide rail 62. The guide rail 62 can ensure a smooth operation of the pullout 56 as it slides in and out. The pullout 56 can be configured to receive and secure the swappable appliance 54. In some embodiments the pullout 56 can be lockable. In the locked position the pullout 56 can hold the swappable appliance 54 within the front shell 26. In the unlocked position the pullout 56 can be moved outside of the front shell 26, bringing the swappable appliance 54 with it. In this way, the pullout 56 can facilitate easy installation/uninstallation of the swappable appliance 54.

As existing appliances take up much of the indoor space, especially in the kitchen, apparatus 50 can advantageously combine many of these appliances and utilize the synergies between the appliances to further reduce the amount of space needed for the apparatus 50. The easily replaceable appliances and units further increase the efficiencies and installation times of the apparatus 50 and associated appliances. The apparatus 50 can also more easily be upgraded in the embodiments that use this modular design.

The apparatus 50 can be configured with tie-ins 58 for gas or fluid and with electrical outlets. The fluid tie-in can be at least one of cold and hot fluid lines. In some embodiments, the apparatus 50 can comprise shut-off valves for the gas or fluid tie-ins. In some embodiments the electrical outlets can be part of power supply 64.

In some embodiments, the apparatus 50 can have a heat shield 60. The heat shield 60 can be between the front shell 26 and the back shell 14. The heat shield 60 can separate the different appliances or units within the apparatus 50. For example, the heat shield 60 could be between the stove 1 and a cabinet 52, or as another example, the heat shield 60 could be between the water heater 2 and the swappable appliance 54. The apparatus 50 can comprise multiple heat shields 60. The heat shield 60 can insulate the temperature changes and the heating activity occurring in one appliance or unit from affecting other appliances or units.

In order to accommodate different installation needs, in some embodiments, the water heater 2 can be installed on a shelf 66. The shelf 66 can be fixed or adjustable. The shelf 66 can allow for clearance under the water heater 2 so that components, such as tie-ins, shut-off valves, power supplies, etc. can be installed in the apparatus 50. This can allow the apparatus 50 to accommodate a broad number of appliances and/or swappable appliances 54.

Still referring to FIG. 6, an embodiment of a second use or secondary water heater 90 will be described. The secondary water heater 90 can comprise a heating coil 70. Different embodiments of heating coils 70 can be located in different locations of the apparatus 50 to heat water or fluid that travels through the heating coil 70. For example, the heating coil 70 can include but is not limited to: a stove heating coil 72, a first flue heating coil 74 and a second flue heating coil 76. The heating coil 70 can comprise coiled metal tubing, as shown in FIG. 6. A fluid such as water can be heated by passing through the heating coil 70, i.e. passing through the interior space of the tubing while absorbing heat that is conducted through the metal material of the tubing. When the stove 1 is in use, heat from the stove can heat water passing through the stove heating coil 72. The flue heating coils 74 and 76 can work in a similar manner. For example, heated exhaust that travels through the exhaust system 28 can heat water passing through the first flue heating coil 74. This heated exhaust can be from, for example, either or both of the stove 1 and the water heater 2. It can also be from other appliances, such as a swappable appliance 54 with an exhaust which has been integrated into the exhaust system 28. As another example, exhaust from the water heater 2 can heat water passing through the second flue heating coil 76.

In some embodiments, the secondary water heater 90 can comprise a water pump 82. The water pump 82 can pump water through the heating coil(s) 70. In some embodiments, the secondary water heater 90 can comprise a power supply 64. The power supply 64 can drive the water pump 82.

In some embodiments, water can run continuously through the heating coil(s) 70. In some embodiments, water can run through specific heating coil(s) 70 at specific times. For example, water can run through the stove heating coil 72 when the stove 1 is in use. As another example, water can run through the second flue heating coil 76 when the water heater 2 is in use. In some embodiments with a water pump 82, the secondary water heater 90 can help maintain the water in the system at an elevated temperature by continuously circulating the water through the heating coil(s) 70 when the heating coil(s) are being heated. For example, as long as the stove 1 is in use, the secondary water heater 90 can continue to circulate water through the heating coil 72 even if hot water is not being drawn out of the system by a user. This can help maintain the circulating water at an elevated temperature in preparation for use by a user. In addition, in some embodiments, the water is not circulated when heat is not being generated which would heat the heating coil(s) 70. Thus, for example with an apparatus 50 with a stove 1 and associated stove heating coil 72, when the stove 1 is not in use, the water pump 82 can be shut off so that the water is not continuously circulated through the stove heating coil 72. In this way, energy can be conserved, as the water pump 82 and related power supply 64 can function only when waste heat is available to heat the water within the heating coil(s) 70.

The secondary water heater 90 can be separate from the water heater 2 or it can be made integral with the water heater 2. In some embodiments, the apparatus comprises a secondary water heater 90 but not a water heater 2. As will be appreciated, the connecting pipes throughout the various embodiments can have a valve 93 or a plurality of valves, including one-way valves, to ensure that water or fluid flows only in the proper direction. The valve(s) 93 can also control the amount of fluid flowing to different components of the apparatus 50.

In some embodiments, the apparatus 50 can comprise a collecting tank 78. Heated water from the water heater 2 can be stored in the collecting tank 78. Heated water from the secondary water heater 90 can be stored in the collecting tank 78. The heated water in the collecting tank 78 can be used directly by a user. In a preferred embodiment, the distance between where the water is heated and the collecting tank 78 is minimized to reduce heat losses. The collecting tank 78 can include an insulating shell to help the water retain heat.

In some embodiments, hot water from the collecting tank 78 can be used for certain purposes and hot water from the hot water heater 2 can be used for the same or similar purposes or for different purposes. Hot water can refer to water that has been heated from an initial state and can refer to both water that is warm to the touch or that is hot to the touch. In some embodiments, the water from the collecting tank 78 and from the hot water heater 2 can be the same or different temperatures. For example, in some embodiments, the water from the collecting tank 78 can be warm to the touch and the water from the water heater 2 can be hot to the touch. In such embodiments, water from the collecting tank 78 can be used for washing dishes and hands where water from the hot water heater 2 can be used for showering and bathing.

Looking now to FIGS. 6A-D, some embodiments of a stove burner 21 and stove heating coil 72 are shown. These figures show the interaction of the stove burner 21 and the stove heating coil 72 according to some embodiments. In some embodiments, such as in FIGS. 6A and B, the stove burner can comprise a grate 123 and a stove top burner 125. The grate 123 and stove top burner 125 can be above the surface 127 of the stove. The stove can be a gas stove. In some embodiments, the stove heating coil 72 can be configured to sit on the stove top surface 127 and between the grate 123 and the stove top burner 125. In some embodiments the top of the stove top burner 125 can be below the top of the stove heating coil 72, as is shown in FIG. 6B.

FIG. 6C illustrates a stove burner 21′ of an electric stove. The stove burner 21′ can comprise an electrical heating unit 125′ and a heat conducting surface 129. The electrical heating unit 125′ can contact the heat conducting surface 129. The stove heating coil 72′ can be adjacent to or contacting at least one of the electrical heating unit 125′ and the heat conducting surface 129. In some embodiments, the stove heating coil 72′ can be below or substantially below the stove top surface 127′. In some embodiments, the stove top surface 127′ can be combined with the heat conducting surface 129. In some of these types of embodiments the stove top surface 127′ can be substantially sealed.

FIG. 6D shows some other embodiments of a gas stove. The burner 21″ can comprise grate 123″ and stove top burner 125″. The grate 123″ can be above the surface 127 of the stove. The stove top burner 125″ and the stove heating coil 72″ can be below or substantially below the surface 127″ of the stove. In some embodiments the top of the stove top burner 125″ can be below the top of the stove heating coil 72″, as is shown. In some embodiments, the stove heating coil 72″ can be above or substantially above the top of the stove top burner 125″. In some embodiments at least half of the stove heating coil 72″ is above the top of the stove top burner 125″, as is shown in FIG. 6D.

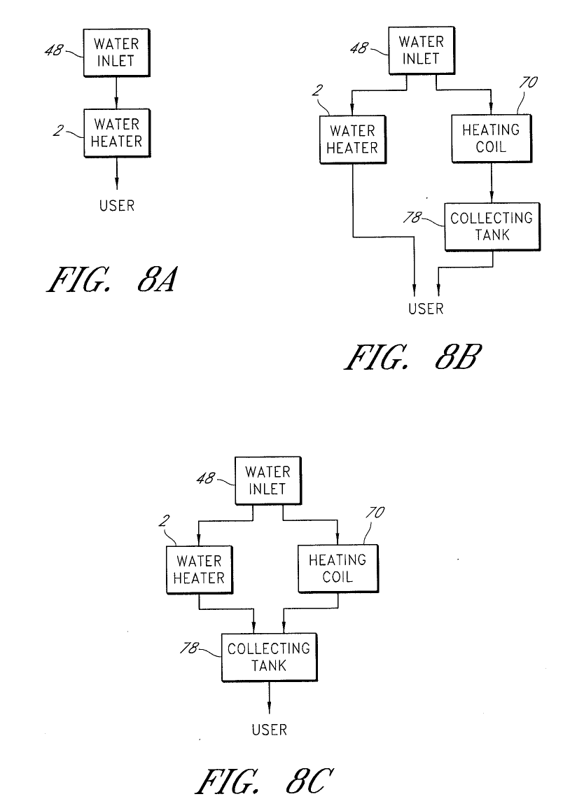

Referring to FIG. 7, a schematic diagram shows some embodiments with both a water heater 2 and a secondary water heater 90 where heated water from both heaters can be mixed together in the collecting tank 78. The diagram also illustrates water pump 82 and shows how the water pump 82 can circulate the heated water from the collecting tank 78 through the secondary water heater 90. As explained previously, this can be done while heat is being applied to the heating coil 70, such as when the stove 1 is in use.

In some embodiments, the water pump 82 can circulate the water through the heating coil(s) 70 and the collecting tank 78 while the appliance creating the heat is being used. If the water is not being used by an end user or by the water heater 2, then the water can be continuously circulated to maintain or to further heat the water. In addition, in some embodiments, the water is not circulated when heat is not being generated which would heat the heating coil(s) 70. For example, when the stove 1 is not in use, the water pump 82 can be shut off so that the water is not continuously circulated through the stove heating coil 72. While at the same time, the water that has been heated can be maintaining in the insulated collecting tank 78. In this way, energy can be conserved, as the water pump 82 and related power supply 64 can function only when waste heat is available to heat the water within the heating coil(s) 70.

In some embodiments, the valve 93 can remain closed so that cold water does not flow directly into the secondary heater 90. In some embodiments, the secondary heater 90 is not connected with the cold water inlet, but rather the secondary heater 90 only draws water from the collecting tank 78.

The apparatus 50 can comprise a temperature controller 15 and a ratio valve 92. When the water heater 2 is in use, the temperature controller 15 can control the flow of gas into the burner 4 through the ratio valve 92. In this way the temperature controller 15 can control the temperature of the water in the collecting tank 78. For example, when water is being heated in both the water heater 2 and the secondary water heater 90 the temperature controller 15 can adjust the gas flow into the burner 4 to increase or decrease the heat of the water coming out of the water heater 2 depending on the temperature of the water coming out of the secondary water heater 90. Thus, the ultimate temperature of the mixed water in the collecting tank 78 can be at or close to the desired temperature.

The temperature controller 15 can comprise a temperature sensor or a plurality of temperature sensors. The temperature controller 15 can adjust the ratio valve 92 based on the temperature readings of the sensor(s). Alternatively the temperature controller 15 can adjust the ratio valve 92 based preconfigured settings related to certain heating settings of appliances that are part of the apparatus 50. For example the heating settings can be heating settings of the stove 1. Thus, if the stove 1 is set to high heat, the temperature controller 15 can adjust the ratio valve to a lower setting then if the stove were set to low heat.

The apparatus 50 can act as a waste heat recovery system. By utilizing waste heat from the appliances, such as the stove 1 and water heater 2, through the secondary heating system 90, energy and financial savings can be achieved because less fuel may be required to heat the water to the desired temperature. The effect on energy savings can be very significant thereby reducing energy consumption and family living expenses. This is because, as explained above, the amount of fuel directed to burner 4 of the water heater 2 can be reduced when the secondary water heater 90 is in operation. The secondary water heater 90 does not use its own fuel but rather uses heat from other appliances that are being run for other purposes. Thus, in some embodiments the secondary water heater 90 is secondary because it is a secondary use of heat that otherwise would not be used. The system also benefits the environment because less excess heat can be exhausted and less carbon dioxide can be emitted.

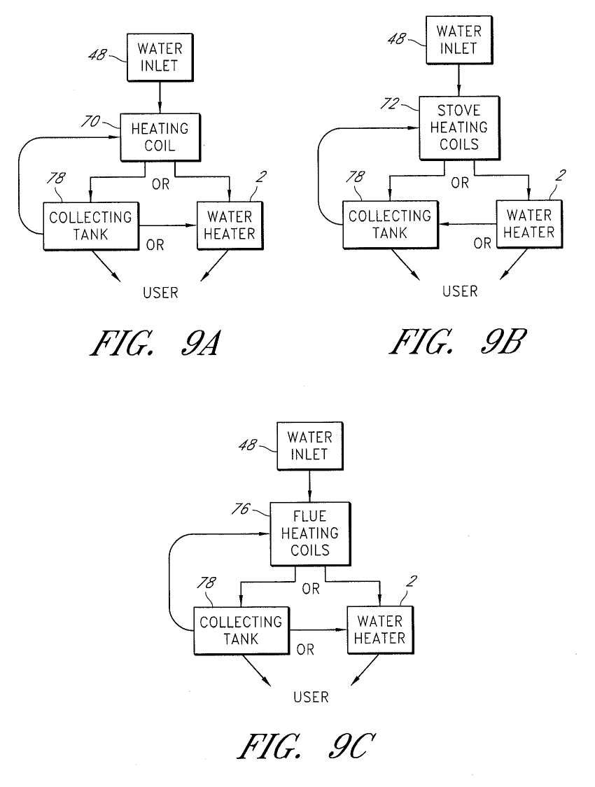

FIGS. 8A-C show flow charts which illustrate several different embodiments of the water heater 2 and secondary water heater 90. In FIG. 8A, water enters the water inlet 48 and is directed to the water heater 2. The heated water can then be used by the user. FIG. 8B illustrates an embodiment where the water heater 2 and secondary water heater 90 are not integrated. The water can take two paths to the user. One path is the same as the path of FIG. 8A and the other path is through the heating coil(s) 70 to the collecting tank 78 and then to the user.

In the embodiment of FIG. 8C, both water paths lead to the collecting tank 78. From the collecting tank 78 the water can be used by the user or recirculated through the heating coil(s) 70. The heating coil(s) 70 can comprise any one or of combination of heating coils such as the stove heating coil 72, first flue heating coil 74 and second flue heating coil 76.

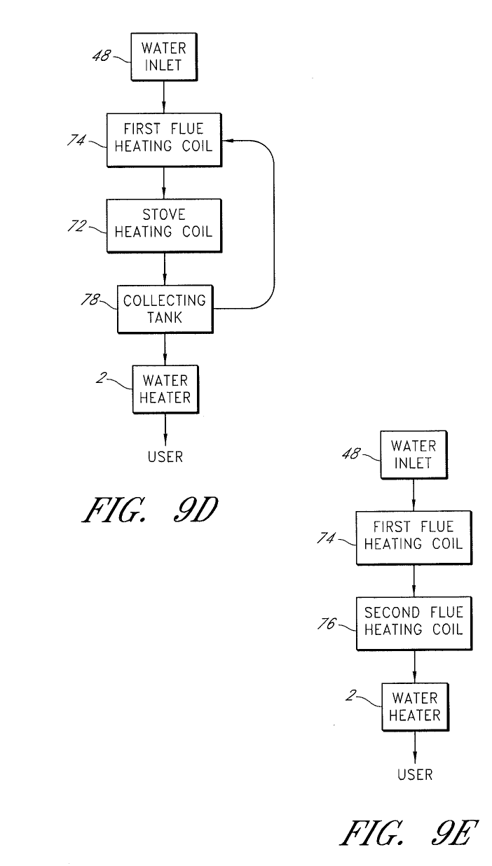

FIGS. 9A-E show flow charts which illustrate several additional embodiments of heating systems. In FIG. 9A, water enters the water inlet 48 and is directed to the heating coil(s) 70. After the water is heated in the heating coil(s) 70, the water can either travel directly to the water heater 2 or to the collecting tank 78. Once in the collecting tank 78 the hot water can be used directly or can be sent to the water heater 2. In the water heater 2 the water can be further heated to a desired temperature prior to use of the hot water. In this embodiment, the heating coil(s) 70 can be used to preheat the water before the water travels to the water heater 2.

FIGS. 9B and 9C are similar to FIG. 9A except that a specific heating coil is specified. In addition, FIG. 9B shows that the heated water can be directed from the water heater 2 to the collecting tank 98. If the stove 1 is in use, water could follow the path in FIG. 9B. If the water heater 2 is in use, water could follow the path in FIG. 9C. If both the water heater 2 and the stove 1 are in use, there could be two flows of water, one that follows each path. In addition, though not shown, water could follow one path and then follow another path. This could be done, for example, before entering the water heater 2.

FIG. 9D illustrates another embodiment of a flow path for when the stove 1 is in use. In this embodiment, the water is shown flowing through the first flue heating coil 74 and then through the stove heating coil 72 before entering the collecting tank 78. After entering the collecting tank 78 the preheated water can be heated further by the water heater 2. The water can also be recirculated if, for example, the water heater 2 is not in use.

FIG. 9E shows another embodiment of a flow path for when the water heater 2 is in use. Water flows through both the first and second flue heating coils 74, 76 before travelling directly to the water heater 2.

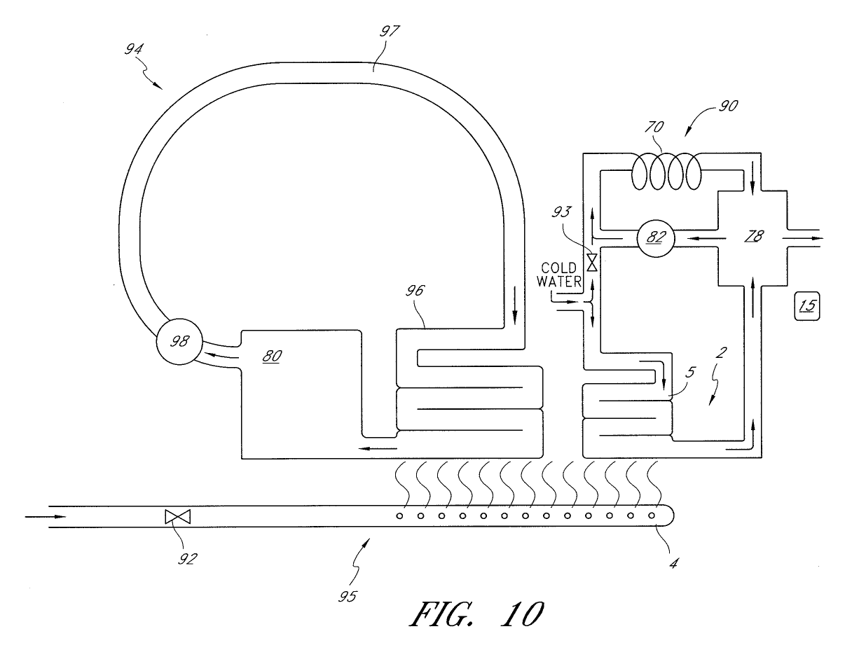

Referring to FIGS. 6 and 10, the apparatus 50 can comprise a room heating system 94. The room heating system 94 can be a closed system where fluid is circulated between a fluid heater 95 and the room(s) to be heated by a series of pipes 97. In some embodiments, the room heating system 94 can comprise a fluid pump 98. In some embodiments, the room heating system 94 can comprise an expanding water tank 80. Heated fluid can be heated in the fluid heater 95 and can pass into the expanding water tank 80. From the expanding water tank 80 the fluid can be directed into the series of pipes 97. The series of pipes 97 can direct the fluid to selected locations, such as rooms, to be heated. The series of pipes 97 can allow heat from the heated fluid to be transferred to the locations along the route of the series of pipes 97. The series of pipes 97 can then direct the fluid back to the fluid heater 95 to start the process all over again. In some embodiments, the expanding water tank 80 can be used to hold redundant water in the system 94. When for example, temperature of the fluid or water in the system 94 causes the overall volume of fluid to increase the excess fluid can flow into the expanding water tank 80. Conversely, when the volume of fluid shrinks fluid can be drawn from the expanding water tank 80 into the system 94.

The fluid heater 95 of some embodiments can comprise a heat exchanger 96 and a burner. As shown in FIG. 10, the fluid heater 95 can use the same burner 4 as the water heater 2. In some embodiments, such as where the fluid heater 95 uses the same burner 4 as the water heater 2, the apparatus can comprise a ratio valve 92. The ratio valve can adjust the flow of fuel to the burner 4 depending on whether the water heater 2 or room heating system 94 are in use. In other embodiments, the burner 4 can be sectioned such that different sections of the burner 4 can function or not function depending on whether the water heater 2 or room heating system 94 are in use. Further, the different sections can be turned on or off by the temperature controller 15.

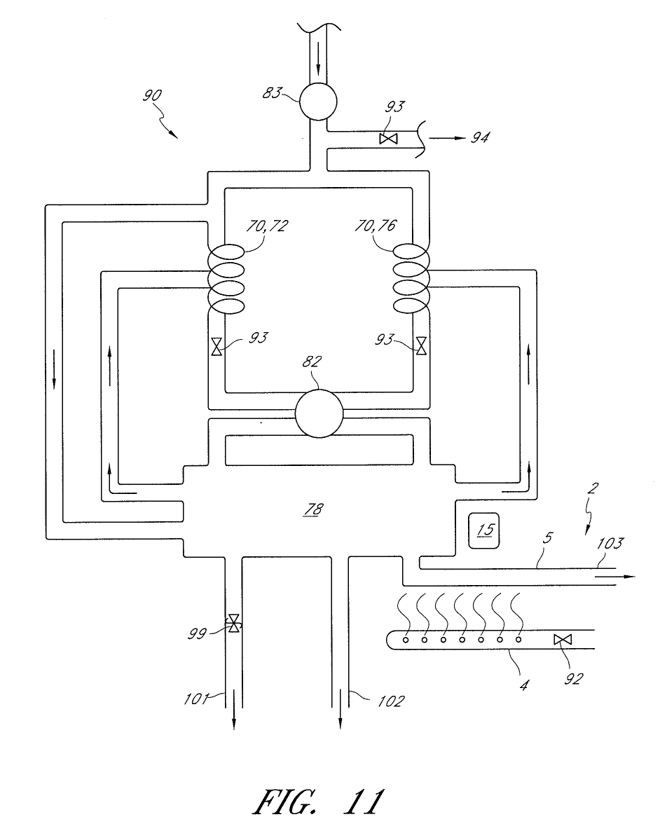

FIG. 11 is a schematic diagram of a water flow of a preferred embodiment of the apparatus 50 (See FIG. 6). From the water inlet, water can flow in many directions. As can be seen, the water can flow in parallel through different aspects of the secondary heater 90 and to the collecting tank 78. Optional water pump 83 can pump the water into the system if necessary. Though only two heating coils 72 and 76 are depicted, the apparatus 50 can comprise more or less heating coils 70. Water can flow into one or more of the heating coil(s) 70. In some embodiments, water can flow only into those coils 70 that are being heated through the use of another appliance. For example, in some embodiments, the stove heating coil 72 can receive a flow of water only when the stove 1 (FIG. 6) is in use. As described herein, the water pump 82 can also pump water from the collecting tank 78 through at least one of the heating coil(s) 70. The water that is heated by the heating coil(s) 70 can enter the collecting tank 78. The collecting tank 78 can have an insulative shell.

In some embodiments, a flow of water can be preheated by the heating coil(s) 70. In some embodiments, as shown in FIG. 11, a flow of water flows directly from the water inlet to the collecting tank 78 without being heated. Water in the collecting tank 78 can be used by a user. In some embodiments, the water in the collecting tank 78 can be used directly by a user. In some embodiments, the water in the collecting tank 78 can be directed to a water heater 2. In some embodiments, a flow of water can be preheated by the heating coil(s) and then further heated in the water heater 2. Such preheating can advantageously conserve energy, provide faster heating and is beneficial to the environment.

The apparatus 50 can comprise an excess hot water release 99. The release 99 can drain hot water from the collecting tank 78. In some embodiments, the apparatus can comprise an outlet 101. Release 99 can drain hot water from the collecting tank 78 through outlet 101. For example, a temperature controller 15 with a temperature sensor can determine that the temperature of the water in the collecting temperature has met or exceeded a set temperature. The temperature controller 15 can control the excess hot water release 99 to decrease the amount of water in the collecting tank 78 while at the same time drawing cooler water from the water inlet to decrease the temperature of the water in the collecting tank 78. For example, the excess hot water release 99 can be configured to automatically open when the water temperature is above 80 degrees Celsius. In some embodiments, the set temperature can be between 80 and 100 degrees Celsius. In some embodiments, the set temperature can be about 90 degrees Celsius. In some embodiments, the set temperature can be 85 degrees Celsius. In some embodiments, the set temperature can be set by the end user.

As explained previously, the water from the collecting tank 78 can be used by a user. For example, water can be directed to the user from outlet 102. In some embodiments, water can be directed to the water heater 2. Water can be directed to the user from outlet 103 after the water has been heated by the water heater 2. The user can use water from the collecting tank 78 and/or water heater 2 for many purposes. For example, the user can use water from the collecting tank 78 to wash the user's hands from outlet 102. Water from outlet 102 can also be directed to an appliance, such as a swappable appliance. A dishwasher, for example, could use water from outlet 102. The dishwasher could have its own heater or could rely on the heat of the water in collecting tank 78. Alternately, the dishwasher or other appliance that requires hot water could use hot water from outlet 103 that has been heated in the water heater 2.

In some embodiments, the apparatus can comprise a room heating system 94. As described herein, the room heating system 94 can be a closed system. In some embodiments, the room heating system 94 can comprise a fluid or water inlet. The fluid or water inlet can allow fluid such as water to enter the system to account for any losses such as those resulting from evaporation.

In some embodiments, the controls for the apparatus can comprise an electrical control panel. In some embodiments the controls can comprise a touch screen. In some embodiments the touch screen can be on the hood.

Although the inventions have been disclosed in the context of certain preferred embodiments and examples, it will be understood by those skilled in the art that the inventions extend beyond the specifically disclosed embodiments to other alternative embodiments and/or uses and obvious modifications and equivalents thereof. The skilled artisan will appreciate, in view of the present disclosure, that certain advantages, features and aspects of certain features disclosed herein may be realized in a variety of other applications, many of which have been noted above. Additionally, it is contemplated that various aspects and features of the inventions described can be practiced separately, combined together, or substituted for one another, and that a variety of combinations and sub-combinations of the features and aspects can be made and still fall within the scope of the inventions. Thus, it is intended that the scope of the inventions herein disclosed should not be limited by the particular embodiments described above.

In the foregoing description of embodiments, various features of the inventions are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, as the following claims reflect, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

What is claimed is:

1. A water heater gas appliance comprising:
a gas inlet;
a water inlet;
a collecting tank;
a cooking stove comprising:
a first gas burner configured for heating and preparing food; and
a gas controller configured to control the flow of gas from the gas inlet
to the first gas burner;
a heating coil;
a water flow control valve configured to control the flow of water to at least one of the heat exchanger and the collecting tank; and
a hot water outlet;
wherein the heating coil comprises at least one of a stove tubing heating coil and a first flue heating coil, wherein the stove tubing heating coil is configured to heat a flow of water when the first burner is in operation and the first flue heating coil is configured to heat a flow of water when exhaust air is passed through an air exhaust system;
wherein the heated water is stored in the collecting tank for use by a user.

2. The water heater gas appliance of claim 1, wherein the heating coil comprises the stove tubing heating coil.

3. The water heater gas appliance of claim 2, further comprising a water pump wherein the water pump is configured to circulate a flow of water between the collecting tank and the stove tubing heating coil.

4. The water heater gas appliance of claim 2, further comprising the first flue heating coil.

5. The water heater gas appliance of claim 4, further comprising a water heater, wherein the water heater comprises a second gas burner and a heat exchanger configured to heat a flow of water through the heat exchanger, the heat exchanger configured for direct heating by the second gas burner.

6. The water heater gas appliance of claim 5, wherein the air exhaust system comprises:
first and second exhaust inlets, wherein the first exhaust inlet is configured to exhaust air from the stove and the second exhaust inlet is configured to exhaust air from the water heater; and
an exhaust outlet configured to exhaust the combined air from both the first and second exhaust inlets.

7. The water heater gas appliance of claim 6, further comprising a second flue heating coil wherein the first flue heating coil is within the exhaust outlet and the second flue heating coil is within the second exhaust inlet.

8. The water heater gas appliance of claim 7, wherein at least one of the heating coils are configured to preheat the flow of water.

9. The water heater gas appliance of claim 2, further comprising a swappable appliance wherein the gas appliance is configured with a space for installing the swappable appliance, the space configured such that the swappable appliance can be swapped out for another swappable appliance and the swappable appliance is selected from the group comprising: a cabinet, a dishwasher, an electric oven, a gas oven and a disinfection cabinet.

10. The water heater gas appliance of claim 5, further comprising a room heating assembly comprising:
a second water heater; and
a plurality of pipes;
wherein the second water heater is configured to be heated by the second gas burner to thereby heat a flow of fluid in the second water heater, the room heating assembly being a closed system configured to circulate the fluid through the plurality of pipes to thereby transfer the heat in the fluid to an environment and is configured to then circulates the fluid back to the second water heater to be heated again.

11. A combustible fuel apparatus comprising:
a fuel inlet;
a water inlet;
a stove comprising:
a first burner; and
a first fuel control valve for controlling a flow of fuel from the fuel inlet to the first burner; and
a water heater comprising:
a first heat exchanger;
a second heat exchanger;
a second burner configured to heat the first heat exchanger; and
a second fuel control valve for controlling a flow of fuel from the fuel inlet to the second burner;
wherein the apparatus is configured to heat the flow of water with either or both of the first and second heat exchangers.

12. The combustible fuel apparatus of claim 11, wherein the second heat exchanger comprises at least one of a stove heating coil and a first flue heating coil, wherein the stove heating coil is configured to heat the flow of water when the first burner of the stove is in operation and the flue heating coil is configured to heat a flow of water when exhaust air is passed through an air exhaust system.

13. The combustible fuel apparatus of claim 12, wherein the second heat exchanger comprises both the stove heating coil and the first flue heating coil.

14. The combustible fuel apparatus of claim 13, wherein the air exhaust system comprises:
first and second exhaust inlets, wherein the first exhaust inlet is configured to exhaust air from the stove and the second exhaust inlet is configured to exhaust air from the water heater; and
an exhaust outlet configured to exhaust the combined air from both the first and second exhaust inlets.

15. The combustible fuel apparatus of claim 14, further comprising a second flue heating coil wherein the first flue heating coil is within the exhaust outlet and the second flue heating coil is within the second exhaust inlet.

16. The combustible fuel apparatus of claim 15, further comprising a collecting tank wherein the first and second heat exchangers are configured to direct heated water to the collecting tank.

17. The combustible fuel apparatus of claim 16, further comprising a water pump wherein the water pump is configured to circulate a flow of water between the collecting tank and the second heat exchanger.

18. The combustible fuel apparatus of claim 11, further comprising a swappable appliance wherein the gas appliance is configured with a space for installing the swappable appliance, the space configured such that the swappable appliance can be swapped out for another swappable appliance and the swappable appliance is selected from the group comprising: a cabinet, a dishwasher, an electric oven, a gas oven and a disinfection cabinet.

19. The combustible fuel apparatus of claim 11, further comprising a water/fuel linkage valve, wherein the water/fuel linkage valve is configured to block a flow of fuel from flowing from the fuel inlet to the second burner when a flow of water is not flowing into the heat exchanger.

20. The combustible fuel apparatus of claim 11, further comprising a temperature controller, wherein the temperature controller is configured to block a flow of fuel from flowing from the fuel inlet to the second burner when the water in the heat exchanger exceeds a set temperature.

21. An exhaust system for a water heater gas appliance comprising:
first and second exhaust air inlets;
an outlet;
an exhaust fan in the first exhaust air inlet; and
a filter in the first exhaust air inlet;
wherein the first and second exhaust air inlets exhaust into the outlet and the second exhaust air inlet is configured to not receive exhaust from the first inlet.

22. The exhaust system of claim 21, wherein the outlet comprises an elbow, the elbow having two parallel chambers extending though at least part of the length of the elbow, wherein one of the two chambers connects with the first inlet and the other chamber connects with the second inlet, the chambers configured such that exhaust from one of the chambers will not travel back to source of the exhaust of the other chamber.

23. The exhaust system of claim 21, wherein the first exhaust air inlet is configured to reduce at least one of the particulate size and amount of particulate matter exhausted to the outlet.

24. The exhaust system of claim 21, wherein the second inlet is configured to receive an exhaust from a gas water heater.

25. The exhaust system of claim 21, wherein the first inlet is configured to receive an exhaust from combusting fuel and food preparations of a cooking stove.

26. The exhaust system of claim 21, wherein the second inlet is behind and substantially parallel to the first inlet.

27. The exhaust system of claim 21, further comprising an exhaust hood.
